(19) United States
(12) Patent Application Publication
(10) Pub. No.: US 2017/0139103 A1
(43) Pub. Date: May 18, 2017

(54) Backlight Unit And Display Device

(71) Applicant: WUHAN CHINA STAR OPTOELECTRONICS TECHNOLOGY CO., LTD., Wuhan, Hubei (CN)

(72) Inventor: Yanxue ZHANG, Shenzhen, Guangdong (CN)

(73) Assignee: Wuhan China Star Optoelectronics Technology Co., Ltd., Wuhan, Hubei (CN)

(21) Appl. No.: 14/768,294

(22) PCT Filed: May 22, 2015
(86) PCT No.: PCT/CN2015/079590

§ 371 Date: Aug. 17, 2015

(30) Foreign Application Priority Data
May 19, 2015 (CN) 201510256805.7

(51) Int. Cl. F21V 8/00

(52) U.S. Cl. CPC G02B 6/0021; G02B 6/0068; G02B 6/005; G02B 6/0003

(57) ABSTRACT

A backlight unit includes a light guide plate (LGP), LED chips, and an optical film. The LGP has an LGP body and a groove disposed on a light incident side of the LGP body. The LED chips are electrically connected to and packaged in the groove. The present invention also proposes a display device having the backlight unit. The LGP and the LED chip are packaged in the present invention. The backlight unit and the structure of the display device can be more stable and compact. The coupling efficiency of the product is obviously enhanced. Since there is no need to use a substrate for fixing the LED chip, production costs also decreases and the size of the bezel of the display device also reduces.

### BACKGROUND OF THE INVENTION

1. Field of the Invention

The present invention relates to the field of backlight display technology, and more particularly, a backlight unit and a display device.

2. Description of the Prior Art

With the development of consuming electronic products, products with high photosynthetic capacity and low costs become very important. Some producers of display devices tend to adopt the method of side-emitting backlight to reduce the thickness of display devices. A side-emitting display device mainly comprises a liquid crystal panel, an optical film, a light guide plate (LGP), and a light-emitting diode (LED) source. A plurality of LEDs are embedded on a substrate, which forms light bars. The light bars are easily fixable. The light bar is disposed on a light incident side of the LGP and fixed with the substrate. However, such a disposition has a disadvantage of light leaking or low coupling efficiency once the design of light distribution of the light incident side of the LGP and the light bar is not proper. Moreover, the thickness of the light bar is always highly related to the thickness of the bezel of the display device.

### SUMMARY OF THE INVENTION

In view of the deficiency of the conventional technology, the present invention provides a backlight unit and a display device for enhancing coupling efficiency and efficiently decreasing the width of the bezel of the display device and production costs.

According to the present invention, a backlight unit comprises: a light guide plate (LGP), comprising an LGP body, and a groove disposed on a surface of a light incident side of the LGP body; a plurality of light-emitting diode (LED) chips, electrically connected to and packaged in the groove; and an optical film.

In one aspect of the present invention, the number of the groove is the same as the number of the LED chip, and each of the grooves is packaged with the LED chip.

In another aspect of the present invention, the number of the groove is one, and the plurality of LED chips are arranged at intervals in the groove.

In another aspect of the present invention, the number of the groove is a plurality of grooves, and the plurality of LED chips are arranged in each of the plurality of grooves.

In another aspect of the present invention, the plurality of grooves are equally spaced and arranged in parallel.

In still another aspect of the present invention, an insulating layer is disposed on the surface of the light incident side of the LGP body.

In yet another aspect of the present invention, phosphor is coated on a surface of the groove.

According to the present invention, a display device comprises the backlight unit as mentioned above and a display panel disposed on the optical film.

In one aspect of the present invention, the display device further comprises a back plate, and the backlight unit is disposed on the back plate.

In another aspect of the present invention, display device further comprises a bezel, and the bezel is glued to the light incident side of the LGP.

The LGP and the LED chip are packaged in the present invention. The backlight unit of the LGP and the structure of the display device can be more stable and compact. The coupling efficiency of the product is obviously enhanced. Since there is no need to use a substrate for fixing the LED chip, production costs also decreases and the size of the bezel of the display device also reduces. Meanwhile, the display effect of the display device is guaranteed because phosphor is coated on the groove of the LED chip of the LGP.

### BRIEF DESCRIPTION OF THE DRAWINGS

FIG. 1 shows a cross-sectional view of a display device according to a first embodiment of the present invention.

FIG. 2 shows a schematic diagram of the display device at the incident side according to the first embodiment of the present invention.

FIG. 3 shows a schematic diagram of the display device at the incident side according to a second embodiment of the present invention.

FIG. 4 shows a schematic diagram of the display device at the incident side according to a third embodiment of the present invention.

### DETAILED DESCRIPTION OF THE PREFERRED EMBODIMENTS

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

### Embodiment 1

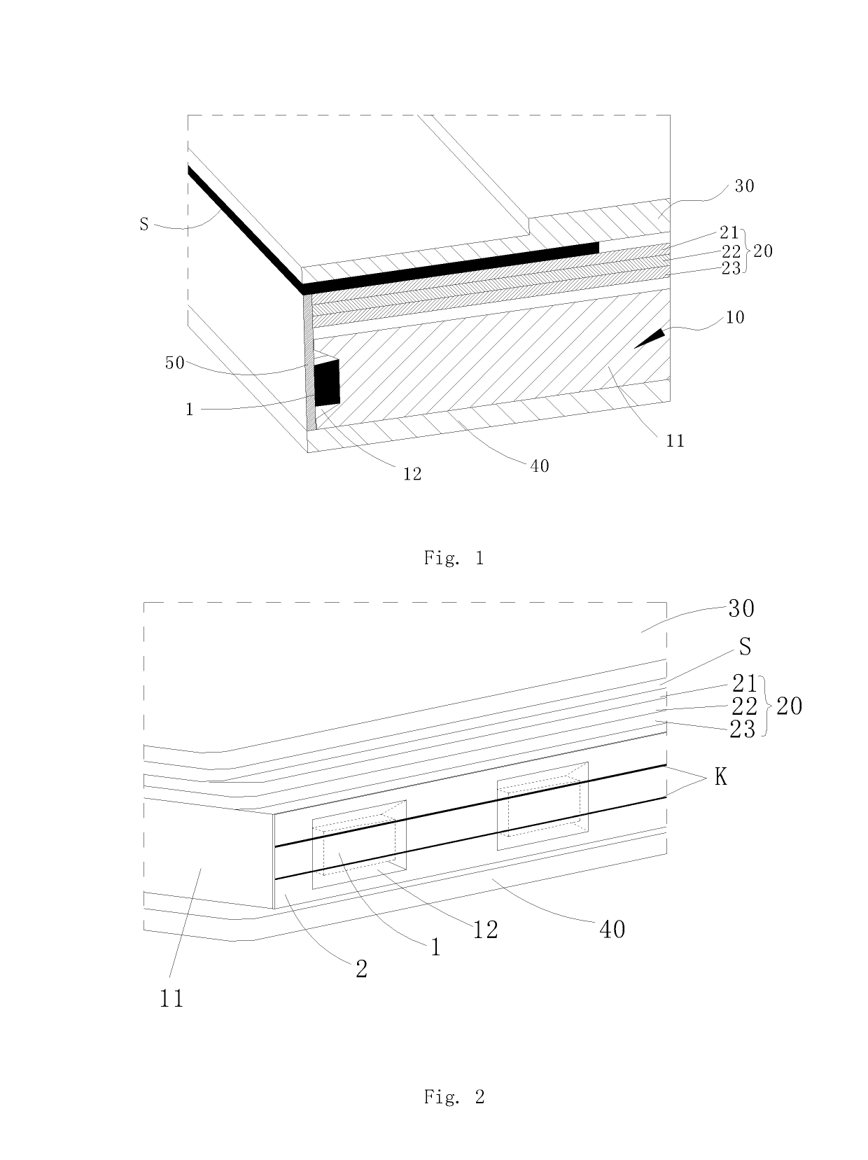

Please refer to FIG. 1. The display device comprises a display panel 30, a back plate 40, a bezel 50, and a backlight unit (not shown in FIG. 1). The backlight unit is disposed on the back plate 40. The display panel 30 is disposed on the facing of the backlight unit. The display panel 30 is opposite to the light-emitting surface of the backlight unit. The edges of the bottom of the display panel 30 are disposed on the upper surface of the bezel 50. The display panel 30 is supported by the bezel 50. The structure of the bezel 50 is a frame. The bezel 50 may be a plastic frame or an iron frame. The backlight unit is disposed in the bezel 50. The bezel 50 not only protects the backlight unit from being harmed but also fixes the backlight unit to a certain extent. In this way, the entire structure of the display device is more stable and compact. The bezel 50 is disposed on the back plate 40 in this embodiment. It is probably that the back plate 40 is accommodated in the bezel 50 in another embodiment. It is also probably that neither the back plate 40 nor the bezel 50 is used in another embodiment.

The backlight unit comprises a plurality of LED chips 1, an LGP 10, and an optical film 20. The LGP 10 comprises an LGP body 11. A groove 12 is disposed on the surface of a light incident side of the LGP body 11. Also, phosphor is coated on the surface of the groove 12. The plurality of LED chips 1 are electrically connected to and packaged in the groove 12. The plurality of LED chips 1 are packaged with epoxy in this embodiment. The plurality of LED chips 1 are packaged in the groove 12 completely. The surface of the LGP 10 is a plane. The bottom of the groove 12 and the side wall of the groove 12 form an obtuse angle so that utilization of light can be improved. The obtuse angle ranges from 120 degrees to 150 degrees, which is most suitable.

The optical film 20 comprises an upper diffuser 21, a brightness enhancement Film (BEF) 22, and a lower diffuser 23. The upper diffuser 21, the BEF 22, and the lower diffuser 23 are stacked on the optical film 20 from top to down. The lower diffuser 23 is disposed on the upper surface of the LGP 10. The upper diffuser 21 is disposed on the lower surface of the display panel 30. Specifically, the display panel 30 is glued to the upper surface of the upper diffuser 21 and the upper surface of the bezel 50 with a dodging glue S at both sides. The dodging glue S further prevents light leaked out of the both sides. The plurality of LED chips 1 generate light. The light scatters through the LGP 10. The light is concentrated by the lower diffuser 23 and is evenly projected onto the BEF 22. The light emitted by the BEF 22 is gathered by the upper diffuser 21. The gathered light is evenly emitted by the upper diffuser 21. The emitted gathered light is used as an even backlight source of the display panel 30.

Please refer FIG. 2 as well. An insulating layer 2 is coated on the surface of the LGP 10 where the plurality of LED chips 1 are packaged. The insulating layer 2 can be disposed on the surface of the LGP 10 in other ways. The number of the groove 12 is the same as that of the LED chip 1 in this embodiment. Each of the grooves 12 is packaged with an LED chip 1. The anode of the LED chip 1 is electrically connected to two different lead wires K. The cathode of the LED chip 1 is electrically connected to two different lead wires K. With the lead wires K, the anode and cathode of the LED chip 1 are lead out for connection.

The LED chip 1 is packaged in the groove 12 corresponding to one light incident side of the LGP 10. Also, the LED chip 1 is electrically connected through the lead wire K. Since there is no need to use a substrate or a flexible printed circuit (FPC) for fixing the LED chip 1 on the surface of the LGP 10, costs of production are reduced. The coupling efficiency increases and meanwhile the width of the bezel of the display device is thinner, which efficiently increases the display area of the display panel 30.

### Embodiment 2

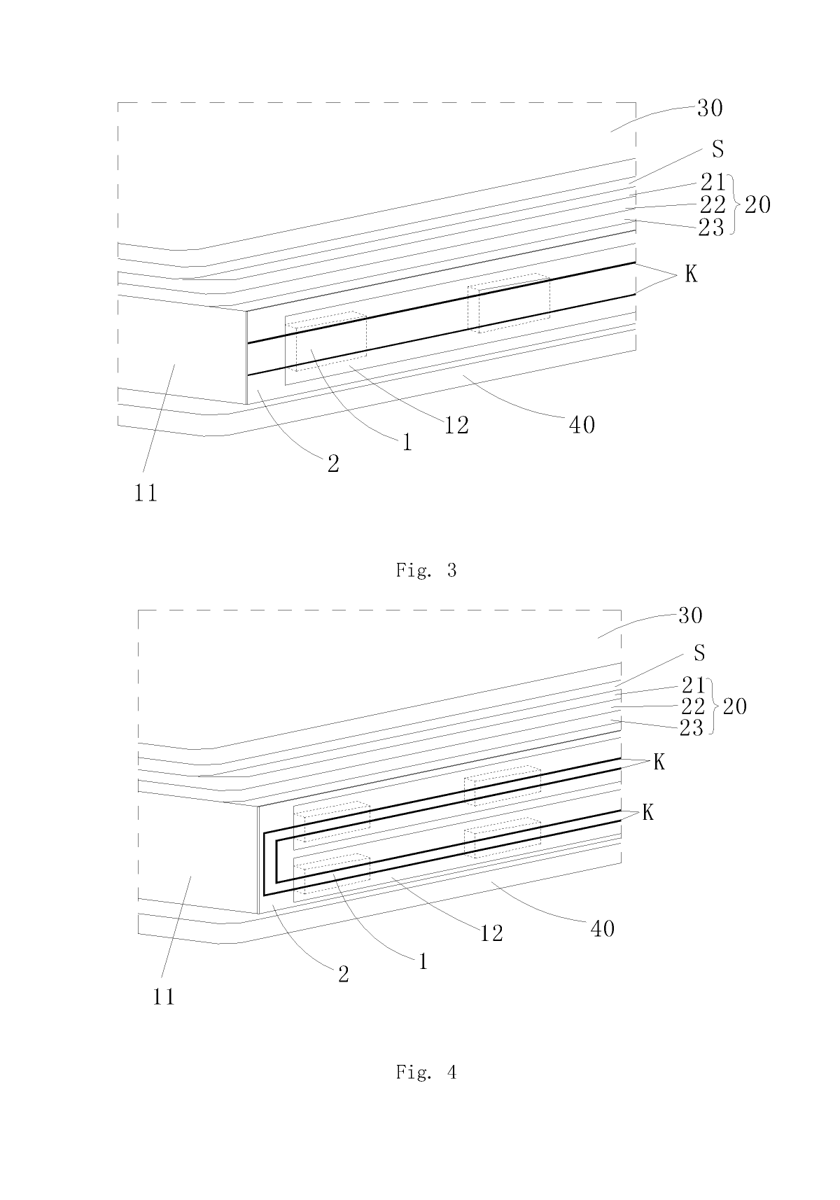

Please refer to FIG. 3. A groove 12 is used in a second embodiment, which is different from the method adopted by the first embodiment. The groove 12 is arranged on the surface of a light incident side of an LGP body 11. A plurality of LED chips 1 are arranged at intervals in the groove 12. The light guiding efficiency of the LGP body 11 provided by the second embodiment is not as good as the LGP body 11 provided by the first embodiment while the coupling efficiency of the LGP body 11 provided by the second embodiment is much better than the conventional LGP body 11.

### Embodiment 3

Please refer to FIG. 4. A plurality of grooves 12 are used in a third embodiment, which is different from the method adopted by the first embodiment. Each of the plurality of grooves 12 comprises a plurality of LED chips 1. The plurality of grooves 12 are arranged in parallel at intervals. A lead wire K is electrically connected with each of the plurality of LED chips 1. The lead wire K and each of the electrically connected LED chips 1 are lead out at the same side for connection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight unit, comprising:
a light guide plate (LGP), comprising an LGP body, and a groove disposed on a surface of a light incident side of the LGP body;
a plurality of light-emitting diode (LED) chips, electrically connected to and packaged in the groove; and
an optical film.

2. The backlight unit of claim 1, wherein the number of the groove is the same as the number of the LED chip, and each of the grooves is packaged with the LED chip.

3. The backlight unit of claim 1, wherein the number of the groove is one, and the plurality of LED chips are arranged at intervals in the groove.

4. The backlight unit of claim 1, wherein the number of the groove is a plurality of grooves, and the plurality of LED chips are arranged in each of the plurality of grooves.

5. The backlight unit of claim 4, wherein the plurality of grooves are equally spaced and arranged in parallel.

6. The backlight unit of claim 1, wherein an insulating layer is disposed on the surface of the light incident side of the LGP body.

7. The backlight unit of claim 1, wherein phosphor is coated on a surface of the groove.

8. The backlight unit of claim 2, wherein phosphor is coated on a surface of the groove.

9. The backlight unit of claim 3, wherein phosphor is coated on a surface of the groove.

10. The backlight unit of claim 4, wherein phosphor is coated on a surface of the groove.

11. The backlight unit of claim 5, wherein phosphor is coated on a surface of the groove.

12. A display device, comprising:
a backlight unit, comprising:
a light guide plate (LGP), comprising an LGP body and a groove disposed on a surface of a light incident side of the LGP body;
a plurality of light-emitting diode (LED) chips, electrically connected to and packaged in the groove; and
an optical film; and
a display panel, disposed on the optical film.

13. The display device of claim 12, wherein phosphor is coated on a surface of the groove.

14. The display device of claim 12, wherein the number of the groove is the same as the number of the LED chip, and each of the grooves is packaged with the LED chip.

15. The display device of claim 12, wherein the number of the groove is one, and the plurality of LED chips are arranged at intervals in the groove.

16. The display device of claim 12, wherein the number of the groove is a plurality of grooves, and the plurality of LED chips are arranged in each of the plurality of grooves.

17. The display device of claim 16, wherein the plurality of grooves are equally spaced and arranged in parallel.

18. The display device of claim 12, wherein an insulating layer is disposed on the surface of the light incident side of the LGP body.

19. The display device of claim 12, wherein the display device further comprises a back plate, and the backlight unit is disposed on the back plate.

20. The display device of claim 12, wherein display device further comprises a bezel, and the bezel is glued to the light incident side of the LGP.
